(19) United States
(12) Patent Application Publication
(10) Pub. No.: US 2023/0069726 A1
(43) Pub. Date: Mar. 2, 2023

(54) GRATING SPECTROMETER HAVING V-SHAPED PROJECTION LIGHT AND CAPABLE OF ELIMINATING COMA ABERRATION

(71) Applicants: Fudan University, Shanghai (CN); Zhongshan Fudan Joint Innovation Center, Zhongshan (CN)

(72) Inventors: Liangyao Chen, Shanghai (CN); Yuxiang Zheng, Shanghai (CN); Haibin Zhao, Shanghai (CN); Rongjun Zhang, Shanghai (CN); Songyou Wang, Shanghai (CN); Jianke Chen, Shanghai (CN); Anqing Jiang, Shanghai (CN); Yuemei Yang, Shanghai (CN)

(21) Appl. No.: 17/657,627

(22) Filed: Mar. 31, 2022

(30) Foreign Application Priority Data
Sep. 1, 2021 (CN) 202111020539.X

(51) Int. Cl. G01J 3/02; G01J 3/18; G01J 3/04

(52) U.S. Cl. CPC G01J 3/0208; G01J 3/021; G01J 3/0291; G01J 3/1804; G01J 3/04; G01J 2003/045

(57) ABSTRACT

The present disclosure discloses a grating spectrometer having a V-shaped projection light path and capable of eliminating coma aberration. The grating spectrometer includes an entrance slit S1, a grating G, an entrance spherical reflector M1, a focusing spherical reflector M2, and an exit slit S2 which are arranged on a light path in sequence in a light transmission direction. The entrance slit S1 and the exit slit S2 are respectively arranged on two sides of the grating G, and a coaxial entrance light path formed by the entrance slit S1 and the entrance spherical reflector M1 and a coaxial diffraction light path formed by the grating G and the focusing spherical reflector M2 form a V-shaped structure by projection in a diffraction plane. The grating spectrometer has actual population and application value.

### TECHNICAL FIELD

The present disclosure relates to the technical field of optical electronic devices, specifically to a grating spectrometer having a V-shaped projection light path and capable of eliminating coma aberration.

### BACKGROUND

A spectrometer is a basic photon wavelength or energy detection and analysis instrument. It has a wide range of application in the field of photoelectrons. A grating spectrometer is most widely used. According to the grating diffraction principle: d sin θₘ=mλ+g₀, where d is a groove spacing of a grating; θₘ is a spreading angle corresponding to a photon with the mth diffraction wavelength of λ in a space; g₀ is a constant related to the design of an optical system; if there is m=1, first-order efficient diffraction photons with a corresponding wavelength can be obtained at different θₘ angular positions; in the design of a traditional grating monochromator, the positions of entrance and exit slits are fixed and unchanged; and one mechanical transmission device is used to control the rotation of an azimuth θₘ angle of the grating to achieve wavelength scanning.

The grating monochromator with the structure of the prior art uses an entrance slit and an optical collimation system to collimate entrance light into parallel light. The entrance light enters a surface of the grating. A mechanical structure is used to rotate the azimuth angle of the grating to achieve wavelength scanning. A focusing optical system is used to focus diffraction spectra of different wavelengths from the grating and then converge them to the exit slit, so as to perform high-resolution detection and analysis on rich spectral information. However, due to the limitation of the optical structure, a reflector off-axis light path design is used in both the collimation of light paths and the detection and analysis of diffracted light. There is a serious asymmetric effect in the off-axis beam transmission, which will cause optical defects such as coma aberration that cannot be overcome and is not conducive to the research and application of high-performance spectrometers. Therefore, a grating spectrometer having a V-shaped projection light path and capable of eliminating coma aberration is urgently needed to solve the above problems.

### SUMMARY

The present disclosure provides a grating spectrometer having a V-shaped projection light path and capable of eliminating coma aberration, which does not depend on a scanning rotation angle of a grating and completely overcome the influence of a coma aberration defect on the spectral resolution in spectrometer application, so as to solve the problems in the prior art.

In order to achieve the above purpose, the present disclosure provides the following technical solution: A grating spectrometer having a V-shaped projection light path and capable of eliminating coma aberration includes an entrance slit S1, a grating G, an entrance spherical reflector M1, a focusing spherical reflector M2, and an exit slit S2 which are arranged on a light path in sequence in a light transmission direction.

The entrance slit S1 and the exit slit S2 are respectively arranged on two sides of the grating G, and a coaxial entrance light path formed by the entrance slit S1 and the entrance spherical reflector M1 and a coaxial diffraction light path formed by the grating G and the focusing spherical reflector M2 form a V-shaped structure by projection in a diffraction plane.

Preferably, a light source forms an entrance light source L1 through the entrance slit S1 and the grating G and forms a collimation light source L2 after being reflected by the entrance spherical reflector M1; the entrance light source L1 and the collimation light path L2 are coaxial on a projection line of the diffraction plane; and an entrance off-axis angle is zero.

Preferably, the collimation light path L2 forms a diffraction light path L3 via diffraction of the grating G; the diffraction light path L3 is reflected by the focusing spherical reflector M2 to form a coaxial diffraction light path L4; the diffraction light path L3 and the coaxial diffraction light path L4 are coaxial on the projection line of the diffraction plane; and a diffraction off-axis angle is zero.

Preferably, the entrance slit S1 is arranged above the grating G; the exit slit S2 is arranged below the grating G or the entrance slit S1 is arranged below the grating G; and the exit slit S2 is arranged above the grating G.

Preferably, a grating combination number of the grating G is n, n≥1; and a mechanical transmission device is used for performing scanning control on the azimuth angle of the grating G.

Preferably, an adjustable width of the entrance slit S1 and an adjustable width of the exit slit S2 are both 0.01 to 1.0 mm.

Compared with the prior art, the present disclosure has the beneficial effects: The entrance slit S1 and the exit slit S2 are respectively arranged on the two sides of the grating G, and the coaxial entrance light path formed by the entrance slit S1 and the entrance spherical reflector M1 and the coaxial diffraction light path formed by the grating G and the focusing spherical reflector M2 form the V-shaped structure by projection in the diffraction plane; a spectral region for full wavelength scanning of an azimuth angle of the grating is unrelated to the grating scanning azimuth angle and does not depend on a scanning rotation angle of the grating, thus effectively overcoming the influence of a coma aberration defect on the spectral resolution in spectrometer application and achieving high-resolution detection and analysis of a full spectral region. The grating spectrometer has actual population and application value.

### BRIEF DESCRIPTION OF THE DRAWINGS

The accompanying drawings are used to provide a further understanding of the present disclosure and constitute a part of this specification to explain the present disclosure together with the embodiments of the present disclosure, and do not constitute restrictions to the present disclosure.

In the drawings:

FIG. 1 is a schematic top view of the structure of the present disclosure;

FIG. 2 is a schematic side view of the structure of the present disclosure.

### DETAILED DESCRIPTION OF THE EMBODIMENTS

The preferred embodiments of the present disclosure are described below with reference to the accompanying drawings, and it should be understood that the preferred embodiments described herein are merely illustrative and explanatory of the present disclosure and are not restrictive of the present disclosure.

Embodiment: A grating spectrometer having a V-shaped projection light path and capable of eliminating coma aberration includes an entrance slit S1, a grating G, an entrance spherical reflector M1, a focusing spherical reflector M2, and an exit slit S2 which are arranged on a light path in sequence in a light transmission direction. The entrance slit S1 and the exit slit S2 are respectively arranged on two sides of the grating G, and a coaxial entrance light path formed by the entrance slit S1 and the entrance spherical reflector M1 and a coaxial diffraction light path formed by the grating G and the focusing spherical reflector M2 form a V-shaped structure by projection in a diffraction plane.

A grating combination number of the grating G is n, n≥1; and a mechanical transmission device is used for performing scanning control on the azimuth angle of the grating G. An adjustable width of the entrance slit S1 and an adjustable width of the exit slit S2 are both 0.01 to 1.0 mm.

Specifically, a light source forms an entrance light source L1 through the entrance slit S1 and the grating G and forms a collimation light source L2 after being reflected by the entrance spherical reflector M1. The entrance light source L1 and the collimation light path L2 are coaxial on a projection line of the diffraction plane; and an entrance off-axis angle is zero. The collimation light path L2 forms a diffraction light path L3 via diffraction of the grating G. The diffraction light path L3 is reflected by the focusing spherical reflector M2 to form a coaxial diffraction light path L4. The diffraction light path L3 and the coaxial diffraction light path L4 are coaxial on the projection line of the diffraction plane; and a diffraction off-axis angle is zero.

The entrance slit S1 is arranged above the grating G, and the exit slit S2 is arranged below the grating G. Or, the entrance slit S1 is arranged below the grating G, and the exit slit S2 is arranged above the grating G. The positions of the entrance slit S1 and the exit slit S2 are interchangeable up and down.

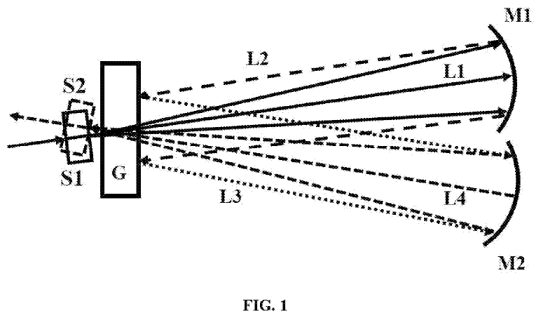

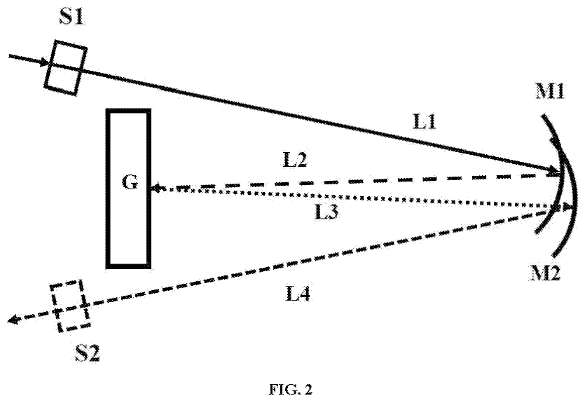

Referring to FIGS. 1-2, the schematic structural diagrams of the spectrometer are described respectively from the top view and the side view. The entrance slit S1 is arranged above the grating G. A spectral signal enters via the entrance slit S1. After the spectral signal passes through the grating G, the entrance light path L1 is formed, and the spectral signal enters the entrance spherical reflector M1, with a focal length F1=500 mm. After the spectral signal is reflected and collimated by the reflector M1, parallel light in the diffraction plane P is formed, thus forming the collimation light path L2 entering the grating G. The mechanical transmission device is used to scan the azimuth angle of the grating G. A work wavelength region is 200 to 1000 nm. Monochromatic light diffracted by the grating G forms the diffraction light path L3 entering the focusing spherical reflector M2, with a focal length F2=500 mm. The light is reflected by the focusing spherical reflector M2 to form the coaxial diffraction light path L4 and is focused and imaged on the exit slit S2. The exit slit S2 is arranged below the grating.

Finally, it should be noted that: the above descriptions are only preferred examples of the present disclosure and are not intended to limit the present disclosure. Although the present disclosure has been described in detail with reference to the foregoing embodiments, those skilled in the art can still modify the technical solutions in the foregoing various embodiments, or equivalently replace partial technical features. Any modifications, equivalent replacements, improvements, and the like that are made within the spirit and principle of the present disclosure shall all fall within the protection scope of the present disclosure.

What is claimed is:

1. A grating spectrometer having a V-shaped projection light path and capable of eliminating coma aberration, comprising an entrance slit S1, a grating G, an entrance spherical reflector M1, a focusing spherical reflector M2, and an exit slit S2 which are arranged on a light path in sequence in a light transmission direction, wherein
the entrance slit S1 and the exit slit S2 are respectively arranged on two sides of the grating G, and a coaxial entrance light path formed by the entrance slit S1 and the entrance spherical reflector M1 and a coaxial diffraction light path formed by the grating G and the focusing spherical reflector M2 form a V-shaped structure by projection in a diffraction plane.

2. The grating spectrometer having the V-shaped projection light path and capable of eliminating coma aberration according to claim 1, wherein a light source forms an entrance light source L1 through the entrance slit S1 and the grating G and forms a collimation light source L2 after being reflected by the entrance spherical reflector M1; the entrance light source L1 and the collimation light path L2 are coaxial on a projection line of the diffraction plane; and an entrance off-axis angle is zero.

3. The grating spectrometer having the V-shaped projection light path and capable of eliminating coma aberration according to claim 2, wherein the collimation light path L2 forms a diffraction light path L3 via diffraction of the grating G; the diffraction light path L3 is reflected by the focusing spherical reflector M2 to form a coaxial diffraction light path L4; the diffraction light path L3 and the coaxial diffraction light path L4 are coaxial on the projection line of the diffraction plane; and a diffraction off-axis angle is zero.

4. The grating spectrometer having the V-shaped projection light path and capable of eliminating coma aberration according to claim 3, wherein the entrance slit S1 is arranged above the grating G; the exit slit S2 is arranged below the grating G or the entrance slit S1 is arranged below the grating G; and
the exit slit S2 is arranged above the grating G.

5. The grating spectrometer having the V-shaped projection light path and capable of eliminating coma aberration according to claim 4, wherein a grating combination number of the grating G is n, n≥1; and a mechanical transmission device is used for performing scanning control on the azimuth angle of the grating G.

6. The grating spectrometer having the V-shaped projection light path and capable of eliminating coma aberration according to claim 1, wherein an adjustable width of the entrance slit S1 and an adjustable width of the exit slit S2 are both 0.01 to 1.0 mm.
